(19) United States
(12) Patent Application Publication
(10) Pub. No.: US 2006/0149599 A1
(43) Pub. Date: Jul. 6, 2006

(54) System and method for automatically generating physician orders for urgent care

(75) Inventors: Charles S. Fox JR., Leawood, KS (US); Kristopher R. Kline, Mission, KS (US); Deborah J. Durrell, Kansas City, MO (US); Mandra L. Isernhagen, Kansas City, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: Cerner Innovation, Inc., Overland Park, KS (US)

(21) Appl. No.: 11/025,993

(22) Filed: Jan. 3, 2005

(51) Int. Cl. G06F 19/00

(52) U.S. Cl. 705/3

(57) ABSTRACT

A system and method are provided for using a caregiver portable computing device for documenting performance of patient-related tasks during an emergency care process. The system includes an emergency interface for regulating communication between a user and the portable caregiver computing device during performance of emergency care processes and a recognition mechanism for recognizing performance of each patient-related task during the emergency care process. The system additionally includes a queue for storing each recognized performed patient-related task and an approval interface for allowing validation of each performed task after each performed task is stored in the queue.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to management of patient care. More particularly, embodiments of the invention are directed to facilitating management of patient care within an automated environment by reliably documenting care processes performed in emergency situations.

### BACKGROUND OF THE INVENTION

With the growing complexity of the healthcare industry, the potential for errors, oversights, and omissions in healthcare management has increased. Particular risks exist in dispensing of medications in an institutional environment.

Mistakes are often made during performance of patient-related tasks due to the sheer number of constantly changing caregivers and the growing complexity of health care. Errors in documentation lead to further treatment errors and also to billing errors. Mistaken patient identification, incorrect medication, or incorrect dosages can lead to critical treatment errors. Risks are further increased by errors in specimen testing and collection. Increased caregiver workloads can lead to cumulative delays in labeling of specimens. The delays frequently result in inaccurate documentation.

When providing treatment, caregivers generally interpret an order for each patient. Each order contains a set of tasks. While the caregiver may only be performing one task from the order, the caregiver still is required to interpret the entire order. For example, an order may require administration of a medication three times a day for three weeks. A task is performed each time medication is administered. To determine if a task should be performed, the caregiver must check the frequency and duration of the order to determine if action is required. These care processes involve an excessive number of steps and increase the potential for error. Additionally, during emergency situations, urgent care processes may be necessary that are not documented in an order. Often, a caregiver will perform the necessary care processes but will not create a record of the care processes. Accordingly, subsequent treatment and billing errors are common.

Currently existing healthcare management systems fail to provide real-time order changes to caregivers and do not allow entry of impromptu orders by authorized caregivers. Furthermore, currently existing systems often do not have the capability to document performance of emergency care processes. The lack of documentation can lead to treatment and billing errors.

A solution is needed for managing healthcare that is both safe and efficient. The processes and components of the solution should drive care activities that are safe, consistent with a plan of care, properly documented and recorded, and protected from failure of primary systems at all times. The solution should further decrease the efforts and steps required of caregivers in order to minimize the opportunity for error. Also, the process allows the user to provide care and document events using information technology when time does not allow for obtaining patient context. Additionally, the solution should ensure that caregivers are able to provide necessary patient care in emergency situations.

### BRIEF SUMMARY OF THE INVENTION

In one aspect, the present invention is directed to a method for documenting performance of patient-related tasks during an emergency care process using a caregiver portable computing device. The method includes receiving a user selection of an emergency interface on the caregiver portable computing device and providing the emergency interface. The method additionally includes accepting user input related to the performance of at least one patient-related task performed during the emergency care process and recording information describing each performed patient-related task. The method also includes consolidating each patient-related task performed during the emergency care process for provider approval.

In an additional aspect, the present invention is directed to a system for using a caregiver computing device for documenting performance of patient-related tasks during an emergency care process. The system includes an emergency interface for regulating communication between a user and the portable caregiver computing device during performance of emergency care processes. The system additionally includes a recognition mechanism for recognizing performance of each patient-related task during the emergency care process and a queue for storing each recognized performed patient-related-task. The system may additionally include an approval interface for allowing validation of each performed task after each performed task is stored in the queue.

### BRIEF DESCRIPTION OF THE DRAWINGS

The present invention is described in detail below with reference to the attached drawings figures, wherein:

FIG. 1 is a block diagram illustrating components of a system for managing patient care in accordance with an embodiment of the invention;

FIG. 2 is a block diagram illustrating components of a system for managing patient care in accordance with an alternative embodiment of the invention;

FIG. 3 is a block diagram illustrating components of a central information system in accordance with an embodiment of the invention;

FIG. 4 is a block diagram illustrating a central database of the central information system in accordance with an embodiment of the invention;

FIG. 5 is a block diagram illustrating a caregiver portable computing device in accordance with an embodiment of the invention;

FIG. 6 is a diagram illustrating an identification device in accordance with an embodiment of the invention;

FIG. 7 is a block diagram illustrating a device link micro-server in accordance with an embodiment of the invention;

FIG. 8 is a block diagram illustrating an emergency care process action module in accordance with an embodiment of the invention;

FIG. 9 is a flow chart illustrating an overview of a method for documenting care processes during an emergency in accordance with an embodiment of the invention;

FIG. 10 is a flow chart showing steps for facilitating user entry of emergency care processes in accordance with an embodiment of the invention;

FIG. 11 is a flow chart illustrating system receipt of emergency care processes in accordance with an embodiment of the invention;

FIG. 12 is a flow chart illustrating an authorization care process for allowing a user to authorize a record of emergency care processes performed in accordance with an embodiment of the invention; and

FIGS. 13-21 are screen shots for facilitating documentation of emergency care processes in accordance with embodiments of the invention.

### DETAILED DESCRIPTION OF THE INVENTION

System and Method Overview

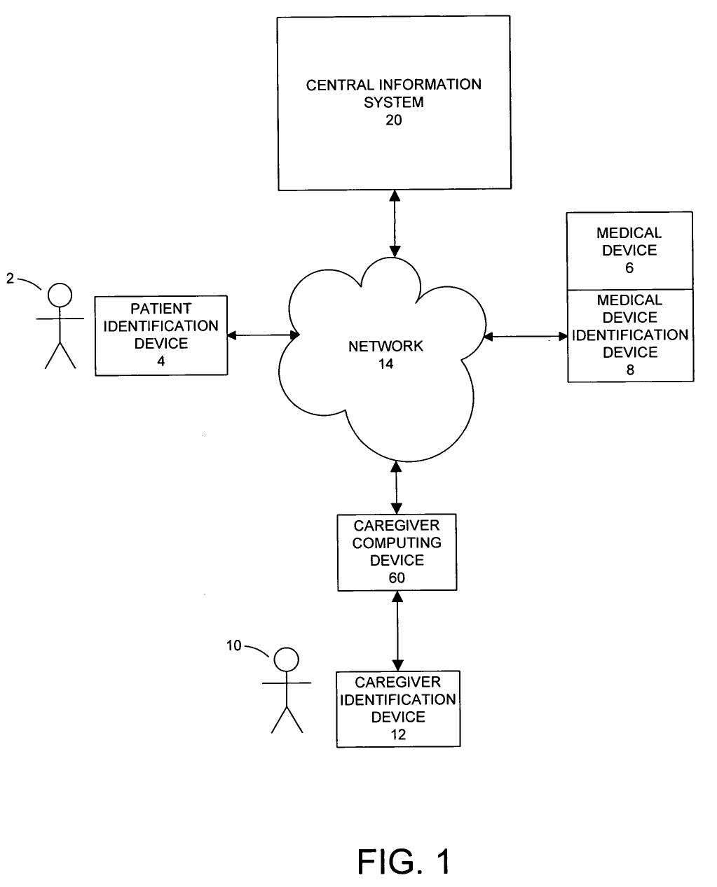

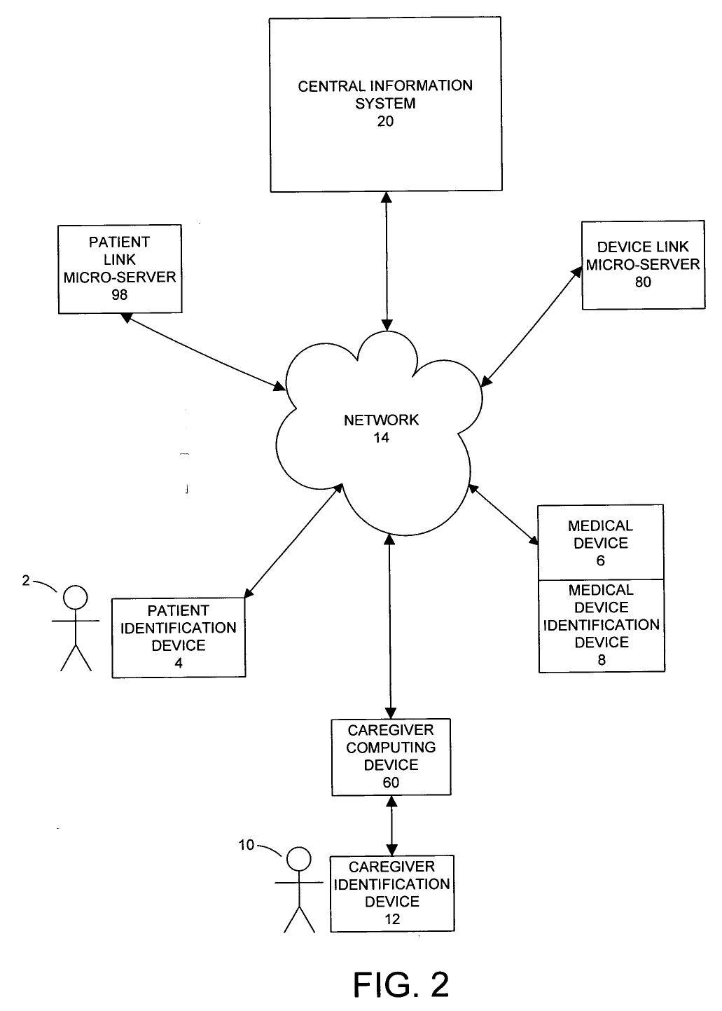

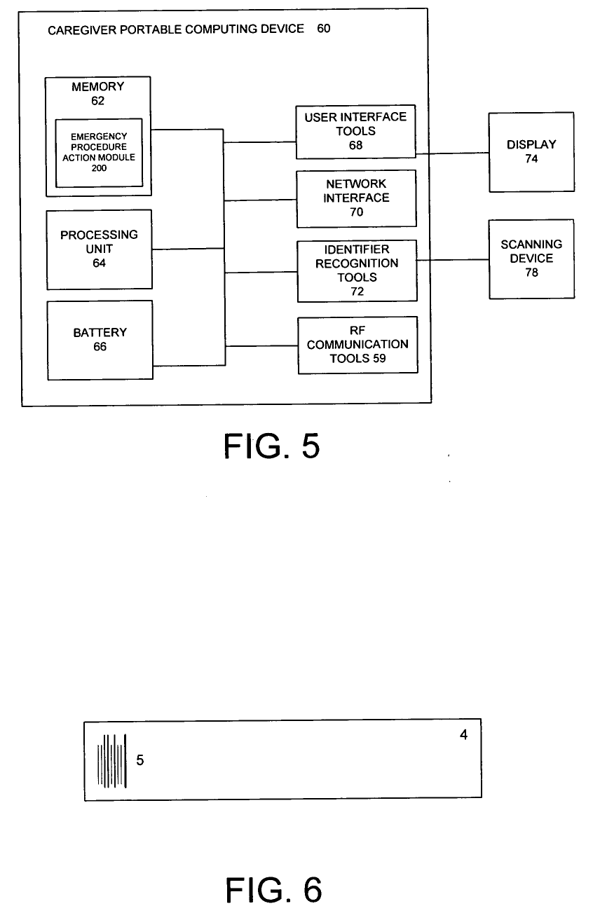

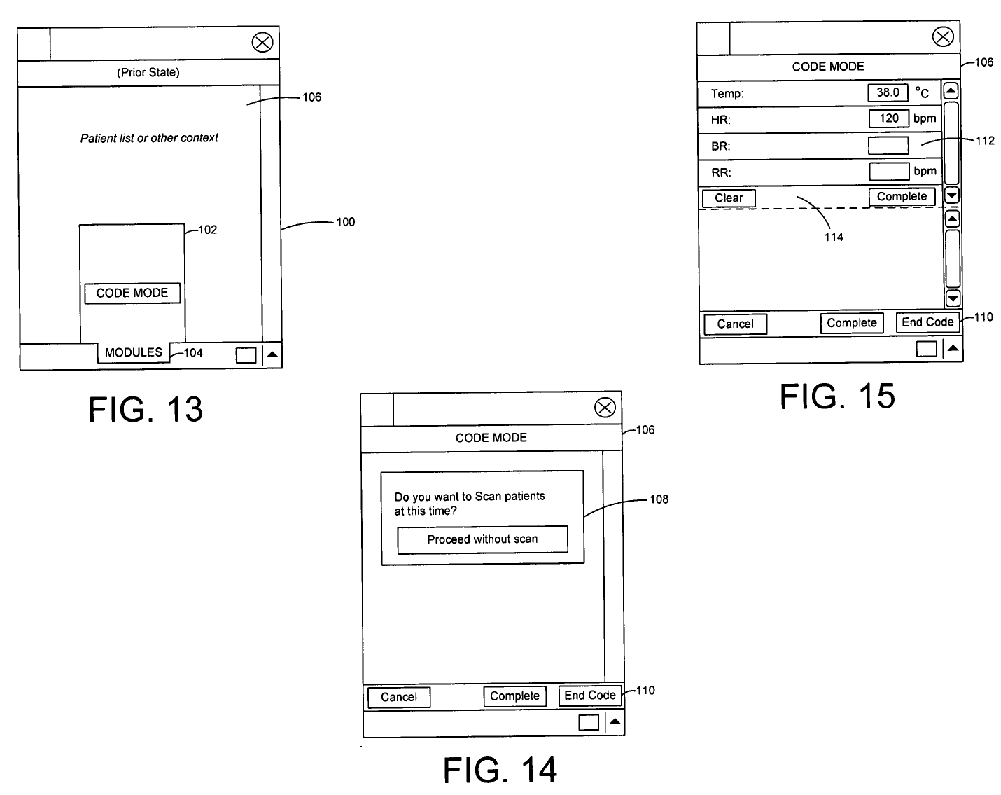

Embodiments of the present invention are directed to a system and method for facilitating management of patient-related tasks during emergency care processes. In particular, embodiments of the system and method of the invention facilitate accurate and efficient documentation of care processes performed. As illustrated in FIGS. 1 and 2, a caregiver portable computing device 60 communicates over a network 14 with a central information system 20, and in some embodiments, with a patient link micro-server 98. Information entered through the caregiver portable computing device 60 thus may be reliably transmitted over a network 14 and recorded in a larger automated system. As illustrated in FIG. 5, the caregiver portable computing device 60 may include an emergency care process action module 200. When a caregiver is required to perform care processes not contained within a pre-existing order, the caregiver may access the emergency care process action module 200. The emergency care process action module 200 may provide a user interface as illustrated in FIGS. 13-22 that facilitates documentation of emergency care processes performed. Having briefly provided an overview of the present invention, embodiments of the invention will be discussed with reference to FIGS. 1-22.

Detailed System Description

Specifically, with initial reference to FIG. 1, a patient identification device 4 may identify a patient 2 and a medical device or medication device identification device 6 may identify a medical device or medication 8. A caregiver identification device 12 may identify a caregiver 10. A central information system 20 and a caregiver portable computing device 60 are capable of communicating over a network 14. The caregiver portable computing device 60 is also capable of processing information from the patient identification device 4, the medical device identification device 8, and the caregiver identification device 12. The caregiver portable computing device 60 can transmit the information to the central information system 20. In this manner, each caregiver 10, each patient 2, and each medication or medical device 6 can be verified with the central information system 20. Although all components are shown as communicating over the network 14, peer-to-peer communication may also be possible. Each of the components of the system is described in greater detail below.

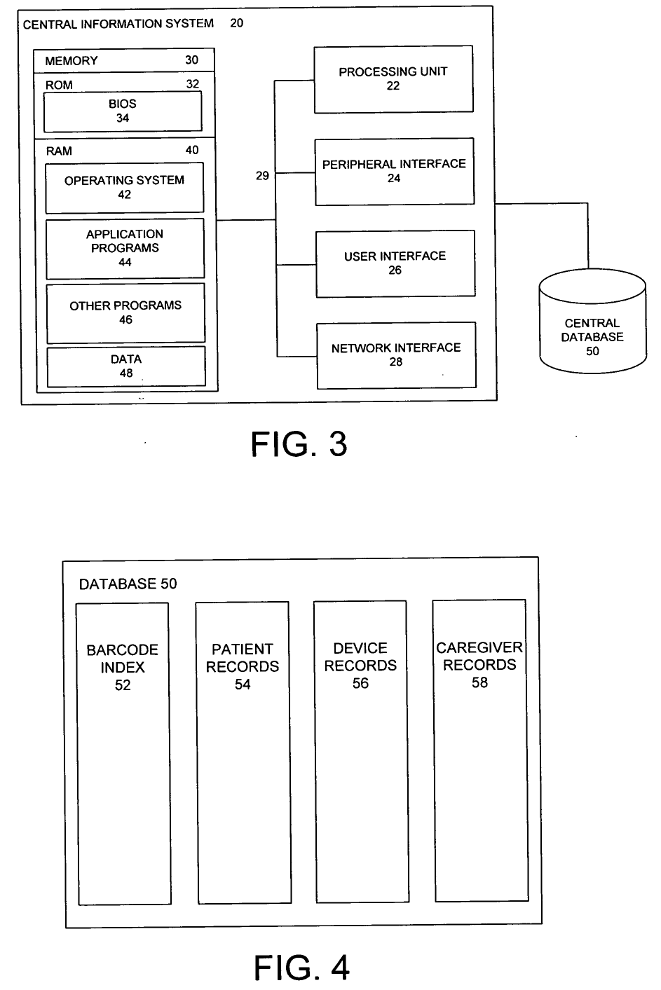

FIG. 3 illustrates an embodiment of the central information system 20. The central information system 20 may include a processing unit 22, a peripheral interface 24, a user interface 26, and a network interface 28. The central information system 20 may also include a memory 30. A system bus 29 couples the aforementioned components. The central information system 20 may also include a central database 50.

The system memory 30 may include computer storage media in the form of volatile and/or nonvolatile memory such as read only memory (ROM) 32 and random access memory (RAM) 40. A basic input/output system 34 (BIOS), containing the basic routines that help to transfer information between elements within the central information system 20, such as during start-up, is typically stored in ROM 32. RAM 40 typically contains data and/or program modules that are immediately accessible to and/or presently being operated on by processing unit 22.

By way of example, and not limitation, FIG. 3 illustrates operating system 42, application programs 44, other program modules 46, and program data 48. The application programs 44 and other programs 46 may be described in the general context of computer-executable instructions, such as program modules, being executed by a computer. The applications programs 44 include components for matching patient data, caregiver data, and medication data in the central database 50 with identifiers transmitted by the caregiver portable computing device 60. Furthermore, the application programs 44 include components for generating a patient task list. The task lists are based upon knowledge databases in the central information system 20 that dictate a particular course of care. These task lists may be contained within the patient records 54 and the caregiver records 58 that are described below with reference to FIG. 4. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The central information system 20 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface and magnetic disk drive and optical disk drive are typically connected to the system bus by a removable memory interface.

A user may enter commands and information into the central information system through the user interface 26 using input devices such as a keyboard and pointing device, commonly referred to as a mouse, trackball or touch pad. Other input devices may include a microphone, satellite dish, scanner, or the like. These and other input devices are often connected to the processing unit 22 through a user input interface 26 that is coupled to the system bus 29, but may be connected by other interface and bus structures, such as a parallel port or a universal serial bus (USB). A monitor or other type of display device may also be connected to the system bus 29 via an interface, such as the peripheral interface 24. In addition to the monitor, computers may also include other peripheral output devices such as speakers and printer.

The illustrated central information system 20 is merely an example of a suitable environment for the system of the invention and is not intended to suggest any limitation as to the scope of use or functionality of the invention. Neither should the central information system 20 be interpreted as having any dependency or requirement relating to any one or combination of components illustrated.

The central information system 20 in the present invention will operate in a networked environment in conjunction with the network 14 as illustrated in FIG. 1, using logical connections to one or more remote computers, such as the caregiver portable computing device 60. As further described below, the caregiver portable computing device 60 may be a personal computer, and typically includes many of the elements described above relative to the central information system 20.

The network 14 may be the Internet and all components of the system may be accessible over the Internet. Logical connections for networking may include a local area network (LAN) or a wide area network (WAN), but may also include other networks. When used in a LAN networking environment, the central information system 20 may be connected to the LAN through the network interface 28 or adapter. When used in a WAN networking environment, the central information system 20 typically includes a modem or other means for establishing communications, such as the Internet. The modem, which may be internal or external, may be connected to the system bus 29 via the user input interface 26, or other appropriate mechanism.

FIG. 4 illustrates an embodiment of the central database 50 that is a component connected with the central information system 20. The central database 50 may include an identifier index 52 linking the identifiers to the identified patients, devices, medications, and caregivers. In the illustrated embodiment, the identifiers are barcodes and the identifier index 52 is a barcode index. However, the identifiers may include an RF identifier (RFID) or any machine readable identifier. Additionally, the central database 50 may include patient records 54, device records 56, and caregiver records 58. The patient records 54 preferably include each patient's treatment history and orders entered by a physician for treatment of each patient. The device records 56 preferably include device settings and capabilities. The caregiver records 58 preferably include records of assigned tasks for each caregiver in the system. The orders and other information can be accessed through the caregiver portable computing device 60 to determine appropriate tasks to be performed on an identified patient.

FIG. 5 illustrates an exemplary embodiment of the caregiver portable computing device 60. The caregiver portable computing device 60 may include a memory 62, a processing unit 64, a battery 66, user interface tools 68, network interface 70, RF communication tools 59, and identifier recognition tools 72. The user interface tools 68 may advantageously be accessible through a built-in display device 74. The identifier recognition tools 72 may be connected with a scanning device 78 such as an embedded barcode scanner.

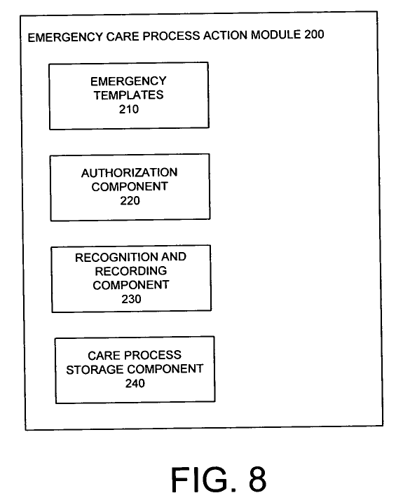

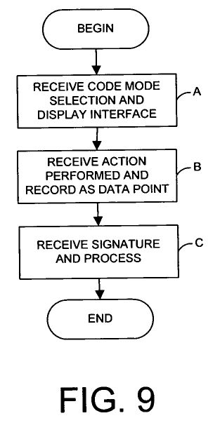

The memory 62 of the caregiver portable computing device 60 may store various program modules, including the emergency care process action module or emergency management module 200. The emergency management module 200 is illustrated in greater detail in FIG. 8. The emergency management module 200 may include emergency templates 210 for guiding a caregiver through an emergency. An authorization component 220 may be provided for post-hoc authorization of documentation relating to emergency care processes performed. A recognition and recording component 230 may be provided to facilitate recognition of each emergency care process and to record information associated with each performed emergency care process. A care process storage component 240 may be provided to store performed care processes in a queue or other structure. All of these components will be further described below in conjunction with the method of the invention shown in FIGS. 9-12.

In an embodiment of the invention the caregiver portable computing device 60 is a handheld personal digital assistant (PDA). The PDA puts the power of the central database 50 in the caregiver's hands at the point of care. The PDA recognizes identifiers associated with the patient 2, caregiver 10, devices 6, or care processes. The PDA prompts the caregiver 10 for necessary actions and information during the care-giving process.

The caregiver portable computing device 60 is used as verification device and in an embodiment of the invention is a barcode scanner for the patient identification device and the caregiver identification device. Caregivers may be provided with varying access levels. For instance, a physician may be able to enter tasks, but some less skilled caregivers may not be permitted such a high access level. In this instance, the caregiver portable computing device 60 is capable of verifying access level through the central database 50 and the caregiver identification device 12.

The caregiver portable computing device 60 accesses the central information system 20 through the network interface 70 and prompts caregivers for scheduled tasks, alerts them to potential error, facilitates documentation, and allows caregivers to review data before posting it to central database. Real time updates and current access orders are available through the caregiver portable computing device 60 in real time.

FIG. 6 illustrates an embodiment of the patient identification device 4 including an identifier 5. The identifier 5 is preferably in machine-readable form and may be a scannable barcode or RFID. The patient identification device 4 may be in the form of a patient wristband. The caregiver identification device 12 preferably also includes the identifier 5. The caregiver identification device 12 may be affixed to a caregiver badge in an embodiment of the invention. The medical device and medication identification device 8 preferably also includes a machine-readable identifier as shown. The identifiers associated with the patient, caregiver, and device are preferably all linked to specific data within the central information system database 50.

Every apparatus and medication used in medical treatment of a patient may be labeled with an identifier such as a barcode. Anything that can be tagged with an identifier can be monitored by the system of the invention. For instance, an IV bag coming from the pharmacy including medications can be labeled at the pharmacy with an identifier such as a barcode. In practice, the caregiver would scan the labeled medication before adding it to a pump. The labeled medication may be compared with the patient identifier 5 and tasks on record such as patient dose, timing, and pump setting. Since the pump can also be labeled with an identifier, the system, through the caregiver portable computing device 60 looks for an IV pump to associate with the identified IV bag. The physical infrastructure provides a mechanism for scanning a barcode that is unique to the IV pump. The tubing attached to the pump and IV bag may also receive an identifier. The system then compares dose, timing, and pump setting with orders on record. In this instance, the caregiver portable computing device 60 could provide a green light if all information matches or an alert if a mismatch occurs. In additional to pumps, any of a number of other medical devices that are attached, inserted, laid upon or otherwise physically associated with a patient may be receive an identifier. These devices include a peripheral IV, a central line, a PA catheter, an arterial line, temporary pacemaker wires, epidural catheters, subdural catheters, endotracheal tubes, chest tubes, surgical drains and urinary catheters and implantable devices such as VP shunts, tracheostomies, cardiac pacemakers, medication pumps, implanted central lines, dialysis shunts and vascular filters. Thus, the attachment type may be identified by the physical connection or the medical device associated with connection. Likewise, the products associated with these devices may also be identified, and may be used similarly to the pump-IV medication combinations described herein.

The contents of manually administered medications may also be labeled with a bar code, RFID, or other machine readable identifier. Labeling reduces the possibility of a patient receiving incorrect medication or receiving medication at inappropriate intervals or in inappropriate dosages. Collected specimens may also be labeled with identifiers. With the addition of a mobile printer (not shown), specimens can be labeled at the moment of collection, thus further reducing opportunities for error.

Labeling each component with an identifier provides a physical structure to make IV pumps and other medical devices part of the care environment and part of the workflow. If more than one medication, IV bag, or pump is present, the system is capable of distinguishing them from one another because of the aforementioned identifiers.

In a second embodiment of the system of the invention as shown in FIG. 2, additional components may be included such as a device link micro-server 80 and a patient link micro-server 98. In implementing the system of the invention, these micro-server components 98 and 80 may both be included or either component 98 or 80 may selectively be implemented.

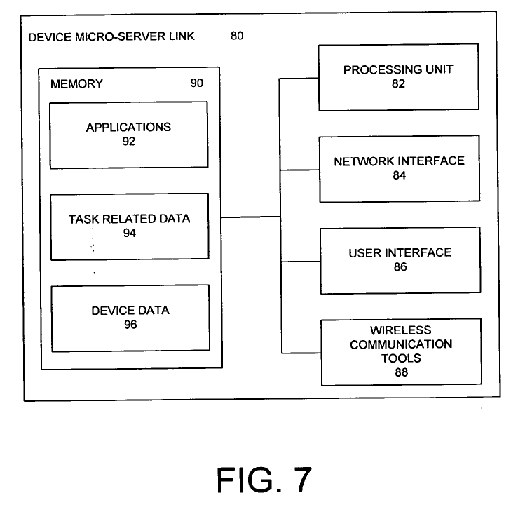

FIG. 7 illustrates an embodiment of the device link micro-server 80. The device link micro-server 80 may include a processing unit 82, a network interface 84, a user interface 86, and wireless or wired communication tools 88. The device link micro-server 80 may also include a memory 90 including applications 92, task related data 94, and device data 96. The device link micro-server 80 has a device driver within its applications 92 and is capable of determining an appropriate communication protocol for the attached device. The device link micro-server 80 uses standard language protocols to communicate with any device and then converts that information to an appropriate format for user by central information system 20. Although all components are shown as communicating over the network 14, peer-to-peer communication may also be possible.

The patient link micro-server 98 may be substantially identical in structure to the device link micro-server 80 and performs a similar function. However, the application programs running on the two devices may differ. The patient link micro-server 98 and the device link micro-server 80 provide caching or local storage of data. The infrastructure of the micro-server devices 80 and 98 allows retention of data and management at nursing unit level. Although the system can function without the micro-servers 80 and 98 as exemplified by FIG. 1, it is desirable to provide an offline data store. Data in the micro-servers 80 and 98 may be stored as tagged extensible mark-up language (XML) data.

Both the patient link micro-server 98 and the device link micro-server 80 are capable of functioning as web servers. The patient link micro-server 98 may function as a web server that caches patient authentication and demographic information for a single associated patient, task data generated from physician orders, and limited clinical result information. Through the wireless or wired communication tools 88, the patient link micro-server 98 communicates with the caregiver portable computing device 60 and the central information system 20 as shown in FIG. 2. The patient link micro-server 98 preferably communicates with the central database 50 via XML but may also support Health Level Seven (HL7) standard protocol and could be configured to operate using the Cemer Millennium® architecture of Cemer Corporation of Kansas City, Mo., or in any appropriate manner in the context of the provided central information system 20.

Each patient may be provided with the patient link micro-server 98. The micro-server 98 may be wireless or hardwired or both to both the central information system 20 and/or the caregiver portable computing device 60, but may record and transmit information about one particular patient. The patient link micro-server 98 stores a snapshot of all information about the associated patient, thus providing back up in case information in the central database 50 becomes inaccessible. The patient link micro-server 98 is capable of functioning as a link between the central database 50 and everything that happens to the patient 2.

Accordingly, the patient link micro-server 98 provides a local, real time, and redundant secondary data store that are specific to the patient. The patient link micro-server 98 is preferably located in the patient room and is connected to the central information system 20 through either a wireless are hardwired connection. The patient link micro-server 98 receives continuous updates to patient-specific information including patient demographics, results, and planned care activities. The data store is temporary, functions during a single episode of care, and may be automatically flushed of data upon discharge of the patient. Thus, the patient link micro-server 98 and the device link micro-server 80 function as localized web servers with information that the caregiver 10 can query.

The caregiver portable computing device 60 with the embedded barcode scanner or other identifier recognition mechanism is preferably capable of communication with the device link micro-server 80 and the patient link micro-server 98 with an RF signal. As discussed above, the patient link micro-server 98 is located in the patient environment and preferably holds the local data store that may be wired to a local network but may also communicate to other components via RF signal. The device link micro-server 80 is attached directly to any patient-attached devices and may communicate to other components via RF signal. Both devices can communicate over the network 14 with the central information system 20 that supplies primary patient-specific information to the patient link micro-server device 98 while the central information system 20 is available.

Both the patient link micro-server 98 and the device link micro-server 80 may continually cache patient specific data from the caregiver portable computing device 60 and any connected medical devices. The cache of information from the micro-servers 80 and 98 may be available from any authorized web browser. The micro-servers 80 and 98 may be directly accessible via a browser over a wired network or using a direct RF network link to the patient link micro-server embedded RF node or the device link micro-server RF node. For access outside the institutional firewall, the micro-servers 80 and 98 may support appropriate encryption schemes. Accordingly, the system continues to support and record care activities even during database downtime because access to the data cached in the micro-servers 80 and 98 is available via a web browser independent of the primary information system is still available.

The micro-servers 80 and 98 are capable of functioning continuously during downtime of the central information system 20 and have the ability to automatically re-synchronize with the central information system 20 when it becomes available. The patient link micro-server 98 receives updates from the central information system 20 based on design criteria and sends updates to the central information system 20 regarding patient activity and acquired device data. Further, the patient link micro-server 98 stores a record of activity performed at the bedside and any data provided to it by adjacent device link micro-servers 80. In the absence of the central information system 20, the patient link micro-server 98 will continue to check activities against its most current activity list and will queue activity updates and data until the central information system 20 signals its availability to accept those updates.

Additionally, as briefly mentioned above, the patient link micro-server 98 may be designed to communicate directly with multiple, bedside patient-attached devices through the device link micro-server 80. In embodiments of the invention, the patient link micro-server 98 is capable of communicating with up to eight device link micro-servers 80.

Data streaming from patient-attached devices is stored continuously in the patient link micro-servers 98 for access by the caregiver 10. The device link micro-server 80 inherits and supports the full range of commands and functions provided by the device manufacturer for each device attached and operates in conjunction with the patient link micro-server 98 to manage the device 6.

The caregiver portable computing device 60 can be used to configure the patient link micro-server 98. In use, the caregiver portable computing device 60 scans the patient identifier 5, an identifier associated with the patient link micro-server 98, and an identifier associated with the device link micro-server 80. This action initiates a routine in the patient link micro-server 98 that initiates a request to the central information system 20 for all patient-specific demographics, results, and activity data for temporary storage in the application server. Devices attached to the device link micro-server 80 become associated to the patient by virtue of their association with the patient-specific patient link micro-server 98.

FIG. 9 illustrates an embodiment of a method for using the system described above with reference to FIGS. 1-8. Prior to the implementation of procedure A, the caregiver may optionally log in to the system by entering the caregiver machine readable identifier on the portable computing device by scanning or other technique. Upon receiving the login information, the system may perform standard authentication procedures for authenticating the caregiver. For instance, the portable computing device may seek verification of the caregiver identity from the central information system database. Upon verification of the caregiver identity, the portable computing device may load and display a patent list for the identified caregiver. The caregiver can then enter the patient's identifier into the system. In the first system embodiment illustrated in FIG. 1, verification of caregiver and patient identity will occur through the central information system. In the second system embodiment illustrated in FIG. 2, verification may occur through the patient link micro-server. Alternatively, in some situations, prior to performing procedure A, the caregiver may not have had the opportunity to perform identification procedures.

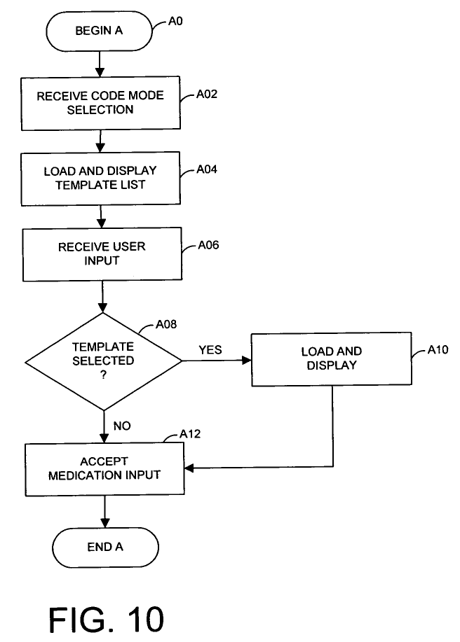

In procedure A, the caregiver portable computing device receives a selection from the caregiver of an emergency or “code mode” display interface. In procedure B, the caregiver portable computing device receives an indication that the caregiver has performed a patient-related task as part of a care process and records the patient-related task as a data point. Procedure B may be repeated a number of times before proceeding to procedure C. In procedure C, the caregiver portable computing device receives a user signature and processes the collected data points to create a post-hoc order. The user performing procedure C will typically be a physician and may not be the same caregiver who performs procedures A and B. Each of procedures A, B, and C is further described below in conjunction with FIGS. 10-12.

FIG. 10 illustrates the details of procedure A. Procedure A begins in step A0. The caregiver portable computing device receives the code mode selection from the caregiver in step A02. In step A04, in embodiments of the invention, the caregiver portable computing device loads and displays a template list. In step A06, the caregiver portable computing device receives user input. The accepted input may be in the form of a scan, a keypad entry, or a template selection. Although the procedures are described below in conjunction with administration of a medication, other procedural inputs are also within the scope of the invention. If a template is selected in step A08, the caregiver portable computing device loads and displays the input in step A10. Whether or not a template is selected, the caregiver portable computing device accepts the medication input in step A12.

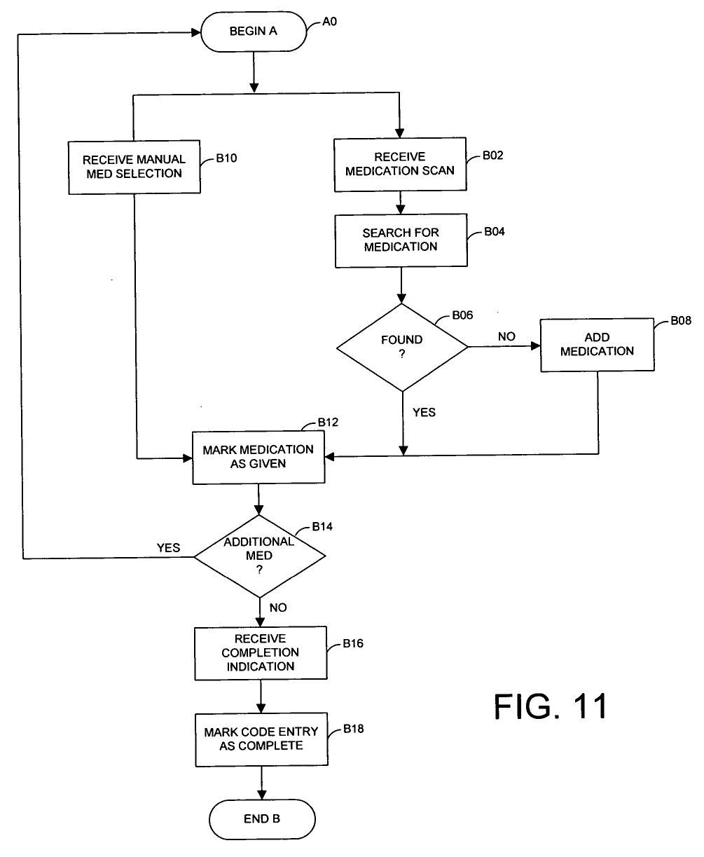

FIG. 11 illustrates details of procedure B. Procedure B begins with B0 and may take one of two paths. A caregiver may either scan an administered medication with the caregiver portable computing device in step B02 or manually select an administered medication using a template provided by the caregiver portable computing device in step B10. If the caregiver portable computing device receives a medication scan in step B02, it searches for the medication to determine if the medication is populated in the template in step B04. If the medication is not found in step B06, the system adds the medication to the template in step B08.

Whether the medication is scanned in step B02 or entered manually in step B10, the medication is marked by the caregiver portable computing device as administered in step B12. In step B14, if additional medications are to be administered, the system returns to step B0. If the medication administration is complete in step B14, the user may enter a completion indication in step B16. In step B18, the system marks the entry as complete. In embodiments, the receipt of action performed in procedure B shall generate orders as set forth in U.S. patent application Ser. No. xx/xx,xxx, entitled System and Method for Processing Ad Hoc Order in an Automated Patient Care Environment, herein incorporated by reference in its entirety.

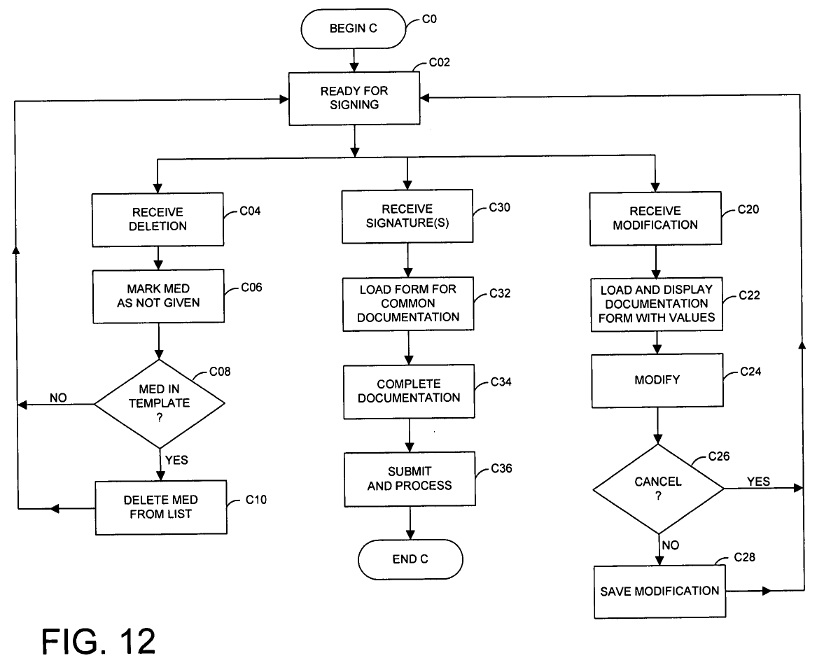

FIG. 12 illustrates the authorization procedure C in accordance with an embodiment of the invention. Procedure C begins in step C0 after procedure B is completed. In step C02, the information related to a group of tasks performed during the emergency is ready for signing. A caregiver or ordering physician may take one of three paths. The caregiver may want to delete entries, sign the entries, or modify the entries. If the caregiver elects to delete an entry, the caregiver portable computing device receives the deletion selection in step C04. In step C06, the system marks the medications as “not administered”. In step C08, the system determines if the medication is populated in the template. If the medication is in the template, the system deletes the medication. The process returns to step C02 so that the caregiver can act on other recorded medications.

If the caregiver chooses to modify the recorded performed tasks, the system receives the modification request in step C20. The caregiver portable computing device loads and displays a documentation form with values in step C22. In step C24, the system modifies the displayed form. In step C26, the caregiver may be prompted either to cancel or save the proposed modification. Whether the caregiver saves or cancels the modification, the process returns to step C02 where additional data points may be ready for authorization.

If the caregiver chooses to sign the recorded data, the system may receive the signatures in step C30. In step C32, the system may load a documentation form and in step C34, the system may complete the documentation and submit and process the documentation in step C36. The processed documentation is retained in the central information system or patient link micro-server.

Although all of the above-identified steps are performed through user interaction with the caregiver portable computing device, it should be understood that central information system and/or the patient link micro-server may communicate with the portable caregiver computing device to provide templates and authorization functions. Either the central information system or the patient link micro-server may store the emergency management module and provide the emergency or code mode interface to the caregiver portable computing device.

FIGS. 13-22 provide sample user interfaces for facilitating performance of the steps described above. FIG. 13 illustrates a caregiver portable computing device display 100. The caregiver may select a code mode or emergency module 102 from available modules 104. Alternatively, a top drop down menu may be provided for selection of the code mode module 102.

FIG. 14 illustrates an emergency screen display as indicated by a code mode title bar 106. A prompt 108 asks the caregiver is she wants to scan patients or proceed without a scan. Task buttons 110 allow a caregiver to exit, complete, or cancel the code mode.

FIG. 15 illustrates a screen display including the code mode title bar 106, a user vital signs display area 112, selectable options 114 including “clear” and “complete” and task buttons 110. In embodiments, a table of contents may organize the information displayed in the screen display of FIG. 15.

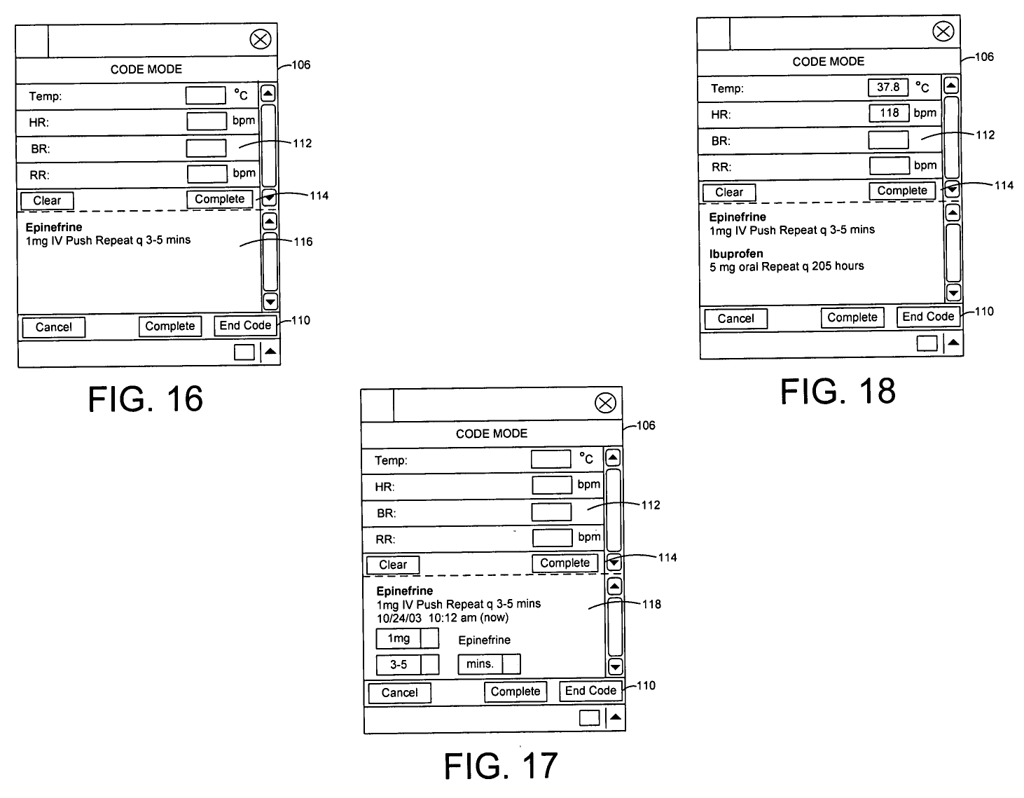

FIG. 16 illustrates the screen of FIG. 15, further including an entered medication area 116. In embodiments of the invention, this medication may have been scanned by the caregiver portable computing device. In other embodiments, the displayed medication may have been selected from an available template.

FIG. 17 illustrates a focus area 118 for a scanned or entered medication. The focus area 118 provides details such as dosage, time and date administered, and intervals at which administration was repeated.

FIG. 18 illustrates a screen display showing multiple entered medications in the display area 116. As each medication is entered, either through manual selection or through scanning, the medication is presented by the caregiver portable computing device in the display area 116.

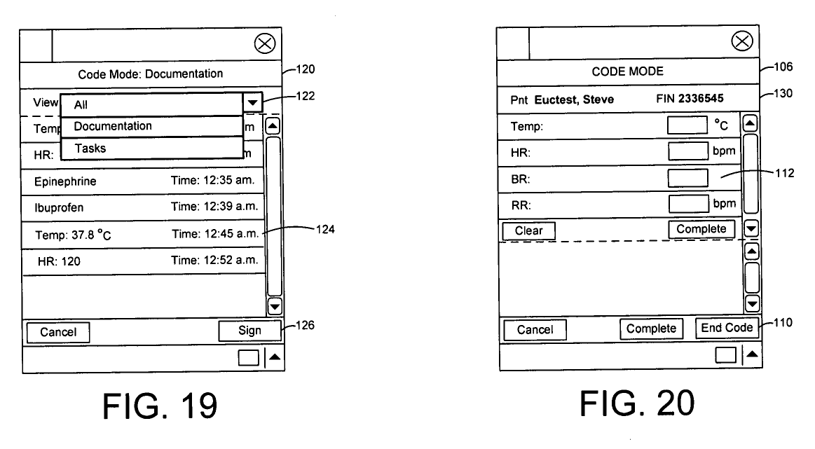

FIG. 19 illustrates a code mode documentation screen as indicated by the title bar 120. A drop down menu 122 includes selectable items such as “all”, “documentation”, and “tasks”. The displayed screen results from the selection of “documentation”. A summary area 124 displays the performed tasks. A “sign” option 126 is provided so that a caregiver may begin the authorization procedure C.

FIG. 20 illustrates a screen that appears if the caregiver portable computing device scanned or otherwise identified the patient prior to the code mode workflow. A patient identification area 130 provides the identifying name and number of the patient.

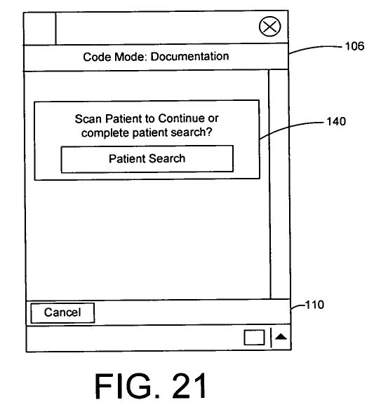

FIG. 21 illustrates a display screen for code mode documentation as shown by the title bar 120. A prompt 140 prompts the caregiver to perform a patient search or to scan the patient using the patient wristband. The screen of FIG. 21 may be shown if the code mode care processes and procedures have been completed, but the patient remains unidentified.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for documenting performance of patient-related tasks during an emergency care process using a caregiver portable computing device, the method comprising:
receiving a user selection of an emergency interface on the caregiver portable computing device;
providing the emergency entry interface;
accepting user input related to the performance of at least one patient-related task performed during the emergency care process;
recording information describing each performed patient-related task; and
consolidating each patient-related task performed during the emergency care process for user approval.

2. The method of claim 1, further comprising providing an authorization interface for allowing a provider to perform post-performance authorization of each recorded patient-related task.

3. The method of claim 2, further comprising providing a modification option on the authorization interface, the modification option allowing the provider to modify each recorded patient-related task.

4. The method of claim 2, further comprising providing a deletion option on the authorization interface, the deletion option allowing the provider to delete each recorded patient-related task.

5. The method of claim 1, wherein providing the emergency entry interfaces comprises loading templates to display the emergency entry interface.

6. The method of claim 5, wherein accepting user input comprises accepting a user selection from a provided care process template.

7. The method of claim 1, wherein accepting user input comprises accepting a scanned barcode identifier.

8. The method of claim 1, wherein recording information describing the patient-related task comprises recording a task performance time.

9. The method of claim 1, wherein recording information describing the patient-related task comprises recording a medication dosage.

10. The method of claim 1, further comprising recognizing an authorized caregiver upon receiving a machine-readable identifier.

11. The method of claim 10, further comprising generating a patient list upon caregiver recognition.

12. The method of claim 1, wherein providing the emergency entry interface comprises providing a prompt for a patient identifier.

13. The method of claim 1, wherein providing the emergency entry interface comprises providing a patient-task display area for displaying each patient-related task performed.

14. The method of claim 1, wherein providing the emergency entry interface comprises providing a prompt for a provider identifier.

15. A system for using a caregiver portable computing device for documenting performance of patient-related tasks during an emergency care process, the system comprising:
an emergency interface for regulating communication between a user and the portable caregiver computing device during performance of emergency care processes;
a recognition mechanism for recognizing performance of each patient-related task during the emergency care process;
a queue for storing each recognized performed patient-related-task; and
an approval interface for allowing validation of each performed task after each performed task is stored in the queue.

16. The system of claim 15, wherein the approval interface comprises an authorization option for allowing the user to perform post-performance authorization of each recorded patient-related task.

17. The system of claim 15, wherein the approval interface comprises a modification option for allowing a user to modify each recorded patient-related task.

18. The system of claim 15, wherein the approval interface comprises a deletion option for the user to delete each recorded patient-related task.

19. The system of claim 15, wherein the emergency interface comprises templates for allowing manual entry.

20. The system of claim 15, wherein the recognition mechanism comprises a mechanism for recognizing a machine-readable identifier.

21. The system of claim 15, further comprising means for recognizing an authorized caregiver upon receiving a machine-readable identifier.

22. The system of claim 21, wherein the emergency interface includes a patient list upon recognition of an authorized caregiver.

23. The system of claim 15, wherein the emergency interface comprises a prompt for a patient identifier.

24. The system of claim 15, wherein the emergency interface comprises a patient-task display area for displaying each patient-related task performed.
